(19) United States
(12) Patent Application Publication
(10) Pub. No.: US 2014/0332552 A1
(43) Pub. Date: Nov. 13, 2014

(54) AUTOMATIC MEDICINE PACKING MACHINE

(71) Applicant: Jun Ho Kim, Daegu (KR)

(72) Inventor: Jun Ho Kim, Daegu (KR)

(73) Assignee: JVM CO., LTD., Daegu (KR)

(21) Appl. No.: 13/979,821

(22) PCT Filed: Jan. 8, 2013
(86) PCT No.: PCT/KR2013/000119

§ 371 Date: Jul. 15, 2013

(30) Foreign Application Priority Data
Jan. 20, 2012 (KR) 10-2012-0006824

(51) Int. Cl. G07F 17/00

(52) U.S. Cl. CPC G07F 17/0092
USPC 221/133

(57) ABSTRACT

Disclosed is an automatic medicine packing machine. Required medicines are packaged in the unit of a dose by automatically discharging the medicines medicine cassettes according to the prescription of a doctor or a pharmacist. A plurality of cassette magazines are drawably installed at an upper body part of the automatic medicine packing machine. Each cassette magazine is provided at one side thereof with a shelf, in which a medicine cassette is arranged, and provided at an opposite side thereof with a passage member to guide the medicines discharged from the medicine cassette.

### TECHNICAL FIELD

The present invention relates to an automatic medicine packing machine, capable of packing required medicines in the unit of a dose by automatically discharging the required medicines from a plurality of medicine cassettes according to the prescription of a doctor or a pharmacist. More particularly, the present invention relates to an automatic medicine packing machine, capable of more effectively performing various works such as an internal cleaning-up work and a medicine supplementing work by arranging medicine cassettes and medicine discharge passages drawably in the form of a drawer.

### BACKGROUND ART

In general, there have been developed and used an automatic medicine packing machine to receive medicines from a plurality of medicine cassettes, which have the medicines such as tablets or capsules according to types, and to consecutively pack the medicines in the unit of a dose.

FIGS. 1 to 3 are a front view, a side view, and a plan view schematically showing an automatic medicine packing machine according to the related art.

Referring to FIGS. 1 to 3, the automatic medicine packing machine according to the related art includes a body 1, a plurality of medicine cassettes C provided at an upper portion of the body 1 to receive tablets or capsules having various sizes and various shapes, hoppers 41, 43, and 45 provided under the body 1 to collect medicines dropped from the medicine cassette C, a printing unit 34 to print various pieces of information on a pack having medicines therein, and a packing unit 30 to pack the medicines collected by the hoppers 41, 43, and 45 by using a wrapping paper.

As shown in FIGS. 1 to 3, according to the automatic medicine packing machine of the present invention, the medicine cassettes C are stacked in a body installation unit 10 and a door installation unit 20 coupled with the body 1 through a hinge 20a.

The medicines discharged from the body installation unit 10 and the door installation unit 20 are collected through passages 11 and 21 and hoppers 41 and 43 and dropped to the packing unit 30.

A passive distribution tray 31 is interposed between the body installation unit 10 and the packing unit 30 to allow a user to passively introduce medicines of types, which are not contained in the medicine cassettes C, therein and to pack the medicines.

The medicines dropped from the hopper 41 at a body side and the hopper 43 at a door side or the medicines dropped from the passive distribution tray 31 are introduced into a pack through the lower hopper 45 provided in the packing unit 30 and packed in the unit of a dose.

The packing unit 30 includes a printer 34 to print information including the name of a patient on a pack 32 transferred from a pack roll 32a through a guide rod 33, a folding member 35 to consecutively fold the central portion of a width of the pack 32, and a heating roller 36 to consecutively seal the folded pack 32. The packed medicines are consecutively discharged out of the automatic medicine packing machine.

The medicine cassettes C must be densely arranged in the body installation unit 10 and the door installation unit 20 so that many types of medicines may be stored at the upper portion of the body 1 of the automatic medicine packing machine. In addition, the medicine cassettes C must be separated for the supplementary work of medicines or a cleaning-up work.

The automatic medicine packing machine according to the related art having the above installation structure of the medicine cassettes C are disclosed in Korean Patent Registration No. 10-0498727, and Korean Utility Model Registration No. 20-0274355.

However, according to the automatic medicine packing machine of the related art in which the medicine cassettes C are stacked in the body installation unit 10 and the door installation unit 20 described above, in order to separate the medicine cassettes C from the body installation unit 10, the medicine cassettes C must be inconveniently exposed by drawing the body installation unit 10 in the state that the door installation unit 20 is open as shown in FIG. 3.

In addition, even if it is necessary to supplement medicines into only one medicine cassette C arranged in the body installation unit 10, since medicines are prevented from being discharged from all medicine cassettes C stacked together in both sides of the body installation unit 10 having the medicine cassette C to be supplemented with the medicines and the medicine cassettes C stacked in the door installation unit 20 to be open in order to draw the body installation unit 10, the time required to pack the medicines is increased.

Further, when it is necessary to clean up the medicine-discharge passage 11 of the body installation unit 10, after opening the door installation unit 20 and drawing the body installation unit 10, all medicine cassettes C stacked in the body installation unit 10 are separated from the body installation unit 10, and metallic plates constituting the passage 11 are separated from the body installation unit 10 in order to perform the cleaning-up work. Accordingly, time and efforts required to clean up the medicine-discharge passage 11 are significantly required.

In addition, since the door installation unit 20 must be rotated at an angle of about 180 in order to draw the body installation unit 10 by opening the door installation unit 20, the automatic medicine packing machine according to the related art must be located at a place spaced apart from the wall of a building or another device by a predetermined distance. Accordingly, when the automatic medicine packing machine according to the related are is installed in a narrow pharmacy, the apparatus is unsatisfactory in terms of the use of a space of the pharmacy.

### DISCLOSURE

### Technical Problem

Accordingly, the present invention has been made keeping in mind the above problems occurring in the prior art, and an object of the present invention is to provide an automatic medicine packing machine, capable of more effectively performing an internal cleaning-up work and a medicine supplementing work by slidably arranging medicine cassettes in a forward-backward direction in the automatic medicine packing machine.

### Technical Solution

In order to accomplish the above object, there is provided an automatic medicine packing machine which consecutively packs various medicines received in a plurality of medicine cassettes in a unit of a dose. The apparatus includes a plurality of cassette magazines drawably installed at an upper body part of the automatic medicine packing machine. Each cassette magazine is provided at one side thereof with a shelf, in which a medicine cassette may be arranged, and provided at an opposite side thereof with a passage member to guide the medicines discharged from the medicine cassette.

Preferably, the cassette magazine includes a left cassette magazine provided at a left side thereof with the shelf, in which the medicine cassette may be arranged, and provided at a right side thereof with the passage member, and a right cassette magazine provided at a right side thereof with the shelf, in which the medicine cassette may be arranged, and provided at a left side thereof with the passage member.

The passage member may include a plurality of guide parts serving as passages vertically extending to guide the medicines discharged and dropped from the medicine cassette such that the medicines are delivered to a hopper provided at a lower body portion of the automatic medicine packing machine, and a plate on which the guide parts are mounted.

The passage member may include a plurality of guide parts mounted on a rear surface of the cassette magazine and serving as passages vertically extending to guide the medicines discharged and dropped from the medicine cassette such that the medicines are delivered to a hopper provided at a lower body portion of the automatic medicine packing machine, and a plate installed in the cassette magazine to cover the guide parts.

Preferably, one edge of the plate is mounted on a surface of the cassette magazine rotatably about a rotational axis.

Each guide part may be detachably attached to the plate.

Each guide part may be detachably attached to the rear surface of the cassette magazine.

At least one elastic protrusion may be mounted on the plate and a coupling unit coupled with the at least one elastic protrusion, which may be elastically deformed, is mounted on the cassette magazine, such that a closed state of the passage member may be securely maintained.

In addition, one magnet may be mounted on at least one of the cassette magazine and the plate, and an attaching unit to which the magnet is attached, may be installed at a remaining one of the cassette magazine and the plate, such that a closed state of the passage member may be securely maintained.

Preferably, a plurality of left cassette magazines and a plurality of right cassette magazines are alternately installed in a same number.

Preferably, the passage member installed in the left cassette magazine is adjacent to the passage member installed in the right cassette magazine.

### Advantageous Effect

As described above, according to the present invention, the medicine cassettes can be slidably arranged in the forward-backward direction in the automatic medicine packing machine, so that the internal cleaning-up work and the medicine supplementing work can be more effectively performed.

### DESCRIPTION OF DRAWINGS

FIGS. 1 to 3 are a front view, a side view, and a plan view schematically showing an automatic medicine packing machine according to the related art.

FIG. 4 is a perspective view showing an automatic medicine packing machine according to the present invention.

FIG. 5 is a plan view showing a portion of a cassette magazine in the automatic medicine packing machine according to a first embodiment of the present invention.

FIG. 6 is a perspective view showing a closed passage member in the cassette magazine of the automatic medicine packing machine according to the first embodiment of the present invention.

FIG. 7 is a perspective view showing an open passage member in the cassette magazine of the automatic medicine packing machine according to the first embodiment of the present invention.

FIG. 8 is a perspective view showing an open passage member in a cassette magazine of an automatic medicine packing machine according to a second embodiment of the present invention.

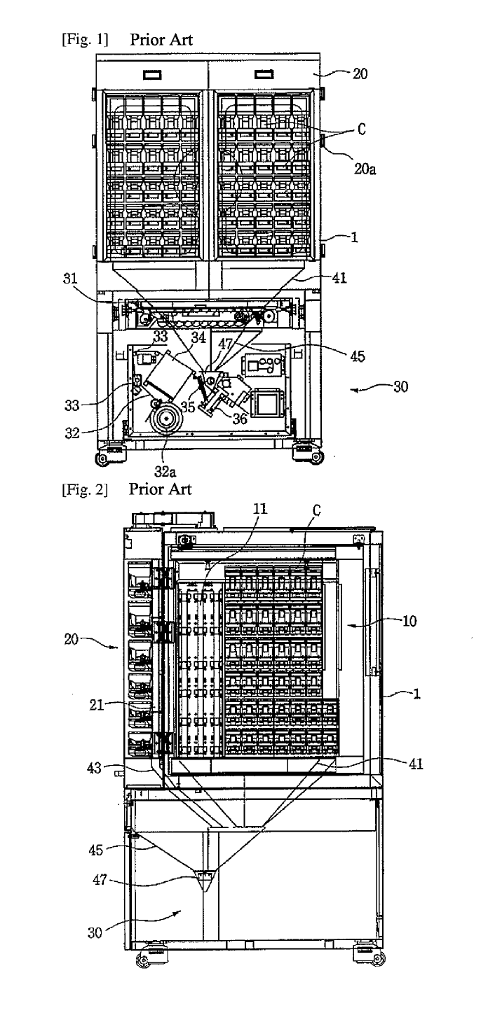

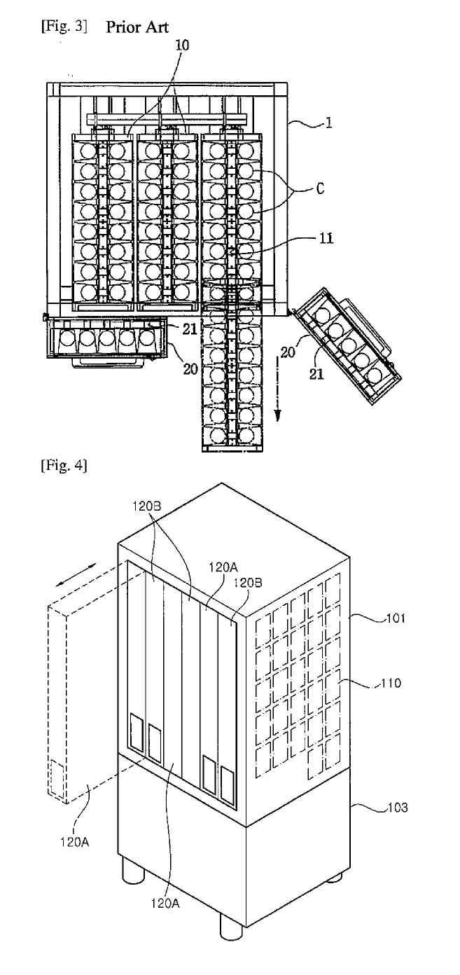

### BEST MODE

### Mode for Invention

Hereinafter, an automatic medicine packing machine according to an exemplary embodiment of the present invention will be described in detail with reference to accompanying drawings.

As shown in FIG. 4, the automatic medicine packing machine according to the exemplary embodiment of the present invention includes a plurality of cassette magazines installed at an upper body portion 101 drawably from the upper body portion 101. A plurality of medicine cassettes 110 are arranged in the cassette magazine to receive tablets or capsules having various sizes and various shapes. In addition, similarly to the structure according to the related art, the automatic medicine packing machine according to the present invention includes a hopper provided at a lower body portion 103 to collect medicines discharged and dropped from the medicine cassettes 110, a printing unit to print various pieces of information on the surface of a pack used for packing the medicines, and a packing unit to pack the medicines collected by the hopper by using a wrapping paper.

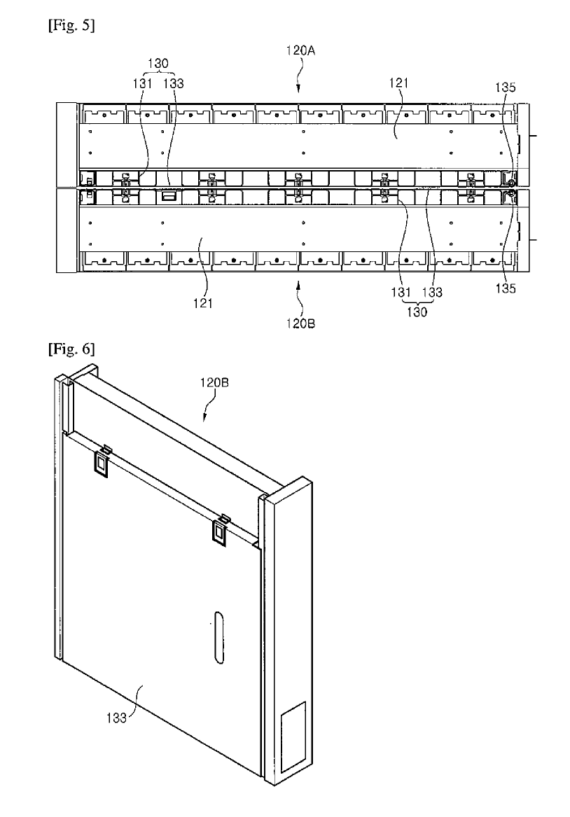

As shown in FIG. 5, the cassette magazine has a structure in which the medicine cassette 110 may be arranged only at one side thereof. In more detail, the cassette magazine includes a left cassette magazine 120A provided at the left side thereof with a shelf 121, in which the medicine cassette 110 may be arranged, and provided at the right side thereof with a passage member 130, and a right cassette magazine 120B provided at a right side thereof with the shelf, in which the medicine cassette 110 may be arranged, and provided at the left side thereof with the passage member 130.

Referring to FIG. 4 again, preferably, a plurality of left cassette magazines 120A and a plurality of right cassette magazines 120B are alternately arranged in the same number in one automatic medicine packing machine.

As shown in FIG. 5, passage members 130 are preferably provided adjacent to each other for the illustrative purpose, but the present invention is not limited thereto. FIG. 5 shows cassette magazines without the medicine cassettes 110.

Since the structure and the method of installing the medicine cassettes in each cassette magazine are generally known to those skilled in the art, the details thereof will be omitted. Meanwhile, naturally, the cassette magazine may include a medicine discharging device having various structures sufficient to discharge a half tablet having no defined shape or released medicine one by one in addition to a typical medicine cassette.

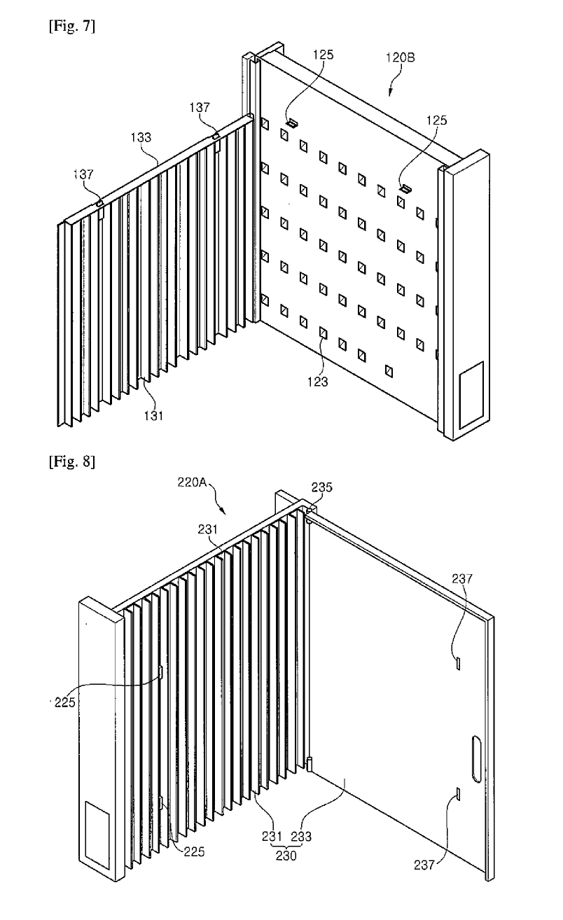

The passage members 130 installed in the left and right cassette magazines 120A and 120B have symmetric structures to each other. Accordingly, the passage member 130 installed in the right cassette magazine 120B will be described as an example with reference to FIGS. 6 and 7.

According to the first exemplary embodiment of the present invention, the passage member 130 includes a plurality of guide parts 131 serving as passages vertically extending to guide the medicines discharged and dropped from the medicine cassette 110 so that the medicines are delivered to the hopper provided at the lower body portion 103, and a plate 133 on which the guide parts 131 are mounted.

The plate 133 of the passage member has one edge mounted on an outer surface of the left or right cassette magazine 120A or 120B rotatably about a rotational axis 135.

When the passage member 130 shown in FIG. 6 is closed, discharge holes 123 formed in the cassette magazine (for the convenience of explanation, an exposed side of the medicine cassette of the cassette magazine is referred as a front surface, and an opposite side of the exposed side is referred to as a rear surface) are not exposed to the outside. The discharge holes 123 vertically arranged in line with each other are surrounded by one guide part 131, and the discharged medicines are delivered to the hopper through the guide part 131. Referring to FIG. 5, although two guide parts 131, which are grouped into one group, may be detachably coupled with the plate 133 through a coupling member such as a screw for the illustrative purpose, at least one or at least three guide parts 131 may be grouped into one group and attached to the plate.

When the passage member 130 shown in FIG. 7 is open, the discharge holes 123 formed in the rear surface of the cassette magazine are exposed to the outside, and, simultaneously, the inner part of the guide part 131 may be exposed to the outside, so that the cleaning-up work and the maintenance work can be easily performed.

Although generally-known various structures such as a magnet and a latch to securely maintain the closed state of the passage member 130 may be utilized, at least one elastic protrusion 137 is mounted on the plate 133 and a coupling unit 125 coupled with the elastic protrusion 137, which is elastically deformed, is mounted on the rear surface of the cassette magazine according to the present embodiment, so that the closed state of the passage member 130 can be maintained.

According to the present invention, since the left and right cassette magazines 120A and 120B are separately drawn, the number of the medicine cassettes 110 drawn from the automatic medicine packing machine at once is reduced to a half the number of the medicine cassettes according to the related art, so that the medicine supplementing work can be more effectively performed.

In addition, if the passage members 130 are open after the left and right cassette magazines 120A and 120B have been drawn, the discharge holes 123 for the medicines, and the inner parts of the guide parts 131 serving as passages to deliver the medicines may be exposed to the outside, so that the cleaning-up work can be significantly simplified. In addition, since the guide part 131 serving as a passage may be separated and cleaned up or replaced, the cleaning-up work and the maintenance work are more conveniently performed.

Hereinafter, a cassette magazine according to a second embodiment of the present invention will be described with reference to FIG. 8.

The cassette magazine according to the second embodiment makes a difference from the cassette magazines 120A and 120B according to the first embodiment, in which the guide part 131 of the passage member is attached onto the place 133, in that the guide part 231 of the passage member is attached onto the rear surface of the cassette magazine instead of the plate 233.

Similarly to the first embodiment, the cassette magazine according to the second embodiment has a structure in which the medicine cassette 110 may be arranged only at one side, that is, only on the entire surface of the cassette magazine.

In addition, the cassette magazine according to the second embodiment may include a left cassette magazine 220A provided at the left side thereof with a shelf, on which the medicine cassettes 110 may be arranged, and provided at the right side thereof with the passage member 230, and a right cassette magazine provided at the right side thereof with a shelf, on which the medicine cassettes 110 may be arranged, and provided at the left side thereof with a right cassette magazine having a passage member installed therein. The passage members 230 installed in the left and right cassette magazines have symmetric structures to each other. Accordingly, the passage member 230 installed in the left cassette magazine 220A will be described as an example with reference to FIG. 8.

According to the second embodiment of the present invention, the passage member 230 includes a plurality of guide parts 231 detachably mounted on the rear surface of the cassette magazine while vertically extending and serving as passages to deliver the medicines discharged and dropped from the medicine cassette 110 to the hopper provided at the lower body portion 103, and a plate 233 installed in the cassette magazine to cover and protect the guide parts 231.

The plate 233 of the passage member has one edge mounted on an outer surface of the left or right cassette magazine rotatably about a rotational axis 235. When the plate 233 is closed, discharge holes 123 formed in the rear surface of the cassette magazine (for the convenience of explanation, an exposed side of the medicine cassette of the cassette magazine is referred as a front surface, and an opposite side of the exposed side is referred to as a rear surface) are not exposed to the outside. The discharge holes, which are vertically arranged in line with each other, are surrounded by one guide part 231 and a plate 233 that vertically extend, and the discharged medicines are delivered to the hopper through the guide part 231. The guide part 231 has through holes formed at a place corresponding to that of the discharge holes, so that the medicines are discharged.

When the passage member 233 shown in FIG. 8 is open, the discharge holes formed in the rear surface of the cassette magazine are exposed to the outside, and, simultaneously, the inner lateral side of the guide part 231 may be exposed to the outside, so that the cleaning-up work and the maintenance work can be easily performed.

Although generally-known various structures such as a magnet or a latch to securely maintain the closed state of the plate 233 of the passage member 230 may be utilized, at least one magnet 225 is mounted on the rear surface of the cassette magazine according to the present second embodiment, and an attaching unit 237, which includes iron that may be attached to the magnet 225, is installed at the position corresponding to the plate 233, so that the closed state of the passage member 130 can be maintained.

According to the present invention, since the left and right cassette magazines are separately drawn, the number of medicine cassettes 110 drawn from the automatic medicine packing machine at once may be reduced to a half the number of the medicine cassettes according to the related art, so that the medicine supplementing work can be more effectively performed.

In addition, if the plate 233 of the passage member 230 is open after the left and right cassette magazines have been drawn, the discharge holes for the medicines, and the inner parts of the guide part 231 serving as a passage to deliver the medicines may be exposed to the outside, so that the cleaning-up work can be significantly simplified. In addition, since the guide part 231 serving as a passage may be separated and cleaned up or replaced, the cleaning-up work and the maintenance work are more conveniently performed.

Although an automatic medicine packing machine according to the present invention has been described for illustrative purposes, those skilled in the art will appreciate that various modifications, additions and substitutions are possible, without departing from the scope and spirit of the invention as disclosed in the accompanying claims.

1. An automatic medicine packing machine, which consecutively packs various medicines received in a plurality of medicine cassettes in a unit of a dose, the apparatus comprising a plurality of cassette magazines drawably installed at an upper body part of the automatic medicine packing machine, wherein each cassette magazine is provided at one side thereof with a shelf, in which a medicine cassette is arranged, and provided at an opposite side thereof with a passage member to guide the medicines discharged from the medicine cassette.

2. The apparatus of claim 1, wherein the cassette magazine includes a left cassette magazine provided at a left side thereof with the shelf, in which the medicine cassette is arranged, and provided at a right side thereof with the passage member, and a right cassette magazine provided at a right side thereof with the shelf, in which the medicine cassette is arranged, and provided at a left side thereof with the passage member.

3. The apparatus of claim 1, wherein the passage member comprises a plurality of guide parts serving as passages vertically extending to guide the medicines discharged and dropped from the medicine cassette such that the medicines are delivered to a hopper provided at a lower body portion of the automatic medicine packing machine, and a plate on which the guide parts are mounted.

4. The apparatus of claim 1, wherein the passage member comprises a plurality of guide parts mounted on a rear surface of the cassette magazine and serving as passages vertically extending to guide the medicines discharged and dropped from the medicine cassette such that the medicines are delivered to a hopper provided at a lower body portion of the automatic medicine packing machine, and a plate installed in the cassette magazine to cover the guide parts.

5. The apparatus of claim 3, wherein one edge of the plate is mounted on a surface of the cassette magazine rotatably about a rotational axis.

6. The apparatus of claim 3, wherein each guide part is detachably attached to the plate.

7. The apparatus of claim 4, wherein each guide part is detachably attached to the rear surface of the cassette magazine.

8. The apparatus of claim 3, wherein at least one elastic protrusion is mounted on the plate and a coupling unit coupled with the at least one elastic protrusion, which is elastically deformed, is mounted on the cassette magazine, such that a closed state of the passage member is securely maintained.

9. The apparatus of claim 3, wherein one magnet is mounted on at least one of the cassette magazine and the plate, and an attaching unit to which the magnet is attached, is installed at a remaining one of the cassette magazine and the plate, such that a closed state of the passage member is securely maintained.

10. The apparatus of claim 1, further comprising a plurality of left cassette magazines and a plurality of right cassette magazines which are alternately installed in a same number.

11. The apparatus of claim 2, wherein the passage member installed in the left cassette magazine is adjacent to the passage member installed in the right cassette magazine.
